(19) United States
(12) Patent Application Publication
(10) Pub. No.: US 2026/0179487 A1
(43) Pub. Date: Jun. 25, 2026

(54) HAZARD LEVEL DETERMINATION DEVICE, HAZARD LEVEL DETERMINATION METHOD, AND STORAGE MEDIUM

(71) Applicant: Panasonic Automotive Systems Co., Ltd., Kanagawa (JP)

(72) Inventors: Hajime HOMMA, Kanagawa (JP); Eiichi KURAISHI, Kanagawa (JP); Daishi IWAMOTO, Kanagawa (JP); Atuhiko HASIGAYA, Kanagawa (JP)

(73) Assignee: Panasonic Automotive Systems Co., Ltd., Kanagawa (JP)

(21) Appl. No.: 19/388,551

(22) Filed: Nov. 13, 2025

(30) Foreign Application Priority Data
Dec. 23, 2024 (JP) 2024-226219
Sep. 22, 2025 (JP) 2025-157202

(51) Int. Cl. G08G 1/0967; G08G 1/01; G08G 1/052; G08G 1/16

(52) U.S. Cl. CPC G08G 1/096791; G08G 1/0112; G08G 1/0133; G08G 1/052; G08G 1/166

(57) ABSTRACT

A hazard level determination device causes: a first moving body to output a signal to a surrounding area; and a second moving body to obtain the signal, and includes: a communication terminal that obtains the signal; a state calculator that estimates a position and a traveling speed of the first moving body based on the signal obtained, and calculates a time required for the second moving body to overtake or pass the first moving body, based on the position and the traveling speed of the first moving body estimated and a position and a traveling speed of the second moving body obtained in advance; and a hazard level determiner that determines a hazard level of the first moving body for the second moving body based on a result of calculation performed by the state calculator and outputs the hazard level determined.

### CROSS REFERENCE TO RELATED APPLICATION

The present application is based on and claims priority of Japanese Patent Application No. 2024-226219 filed on Dec. 23, 2024, and Japanese Patent Application No. 2025-157202 filed on Sep. 22, 2025.

### FIELD

The present disclosure relates to a hazard level determination device, a hazard level determination method, and a storage medium. In particular, the present disclosure relates to a hazard level determination device for the safe traveling of moving bodies.

### BACKGROUND

In public transportation, moving bodies travel in various speeds and directions. For example, Patent Literature (PTL) 1 discloses a traffic safety support system as a technique for improving the safety of the moving bodies in public transportation.

### CITATION LIST

### Patent Literature

PTL 1: Japanese Unexamined Patent Application Publication No. 2023-151565

### SUMMARY

However, the traffic safety support system according to PTL 1 can be improved upon.

A hazard level determination device and the like according to the present disclosure is capable of improving upon the above related art.

A hazard level determination device according to the present disclosure is a hazard level determination device that is provided to a second moving body traveling in a traffic area, the second moving body obtaining a signal output by a first moving body traveling in the traffic area, the first moving body outputting the signal to a surrounding area of the first moving body. The hazard level determination device includes: a communication terminal that obtains the signal; a state calculator that estimates a position and a traveling speed of the first moving body based on the signal obtained, and calculates a time required for the second moving body to overtake or pass the first moving body, based on the position and the traveling speed of the first moving body estimated and a position and a traveling speed of the second moving body obtained in advance; and a hazard level determiner that determines a hazard level of the first moving body for the second moving body based on a result of calculation performed by the state calculator and outputs the hazard level determined.

A hazard level determination device and the like according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a hazard level determination system that includes a hazard level determination device.

FIG. 2 illustrates a first moving body that includes a first communication terminal that emits signals and a second moving body that includes a plurality of second communication terminals.

FIG. 3 illustrates states of a plurality of first moving bodies and a second moving body.

FIG. 4 illustrates a relationship between time and distance in FIG. 3.

FIG. 5A illustrates database of road environment.

FIG. 5B illustrates database of traveling environment.

FIG. 5C illustrates database of street-parked vehicles.

FIG. 5D illustrates database of intersections.

FIG. 5E illustrates database of attributes of first moving bodies.

FIG. 5F illustrates database of the number of times first and second moving bodies pass each other.

FIG. 6 illustrates states of a plurality of first moving bodies and a second moving body in a traffic area.

FIG. 7 is a flowchart illustrating an operation example of the hazard level determination device.

FIG. 8A illustrates states of a plurality of first moving bodies and a second moving body when an obstacle is present in a traffic area.

FIG. 8B illustrates states of the plurality of first moving bodies and the second moving body after an elapse of time from the state in FIG. 8A.

FIG. 9 is a flowchart illustrating an operation example of the hazard level determination device when an obstacle is present in the traffic area.

FIG. 10A illustrates states of a plurality of first moving bodies and a second moving body at an intersection with a blind spot.

FIG. 10B illustrates states of the plurality of first moving bodies and the second moving body after an elapse of time from the state in FIG. 10A.

FIG. 11 is a flowchart illustrating an operation example of the hazard level determination device when a blind spot is present in the traffic area.

FIG. 12A illustrates states of a plurality of first moving bodies and a second moving body in a traffic area with a narrow sidewalk and an obstacle.

FIG. 12B illustrates states of the plurality of first moving bodies and the second moving body after an elapse of time from the state in FIG. 12A.

FIG. 13A illustrates a relationship between time and distance for a plurality of first moving bodies and a second moving body.

FIG. 13B illustrates a relationship between time and distance when the second moving body decelerates out of the plurality of first moving bodies and the second moving body.

FIG. 14 is another flowchart illustrating an operation example of the hazard level determination device when a blind spot is present in the traffic area.

FIG. 15 is a flowchart illustrating an operation example in which the color of the light emitted by a notifier is changed according to the time required for the second moving body to overtake or pass the first moving body.

### DESCRIPTION OF EMBODIMENT

An embodiment according to the present disclosure will be specifically described below with reference to the drawings. The embodiment described below shows a specific example of the present disclosure. Numerical values, shapes, materials, structural elements, the arrangement and connection of the structural elements, steps, the order of the steps, and the like shown in the following embodiment are examples, and are not intended to limit the present disclosure. Among the structural elements in the following embodiment, structural elements which are not recited in the independent claim are described as optional structural elements.

Note that the drawings are represented schematically and are not necessarily precise illustrations. As such, the scaling, etc., depicted in the drawings is not necessarily accurate. Additionally, like reference signs indicate like elements in the drawings, and overlapping descriptions thereof are omitted or simplified.

Hereinafter, an embodiment will be specifically described with reference to the drawings.

### Embodiment

### Configuration

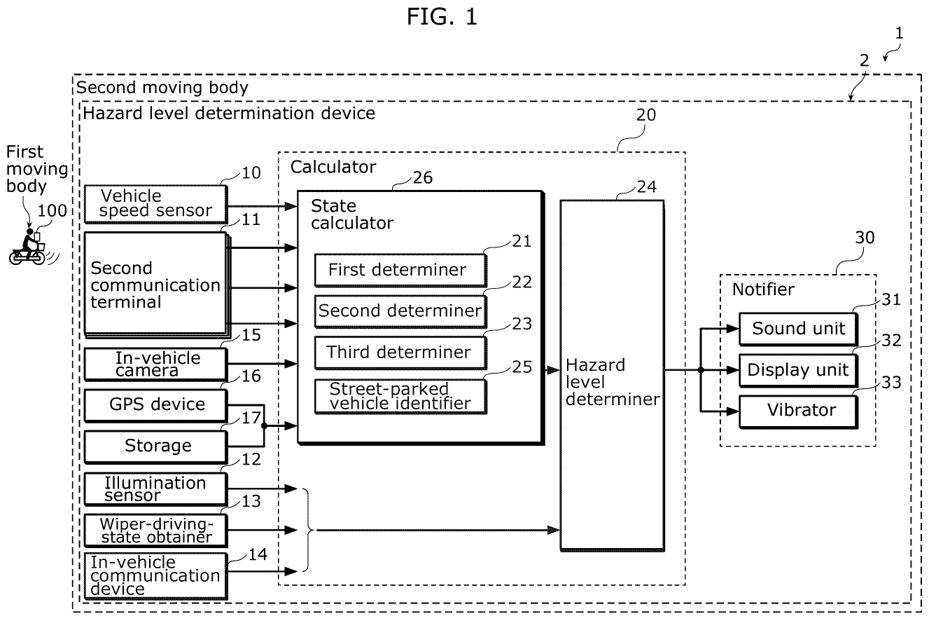

First, with reference to FIG. 1 to FIG. 5F, hazard level determination system 1 that includes hazard level determination device 2, a hazard level determination method, and a program according to the present embodiment will be described.

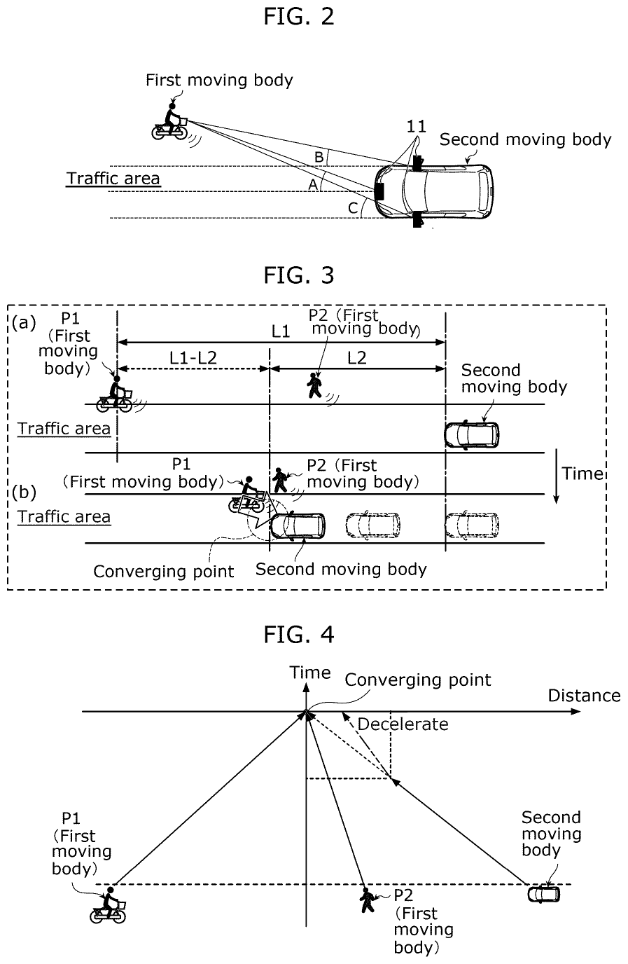

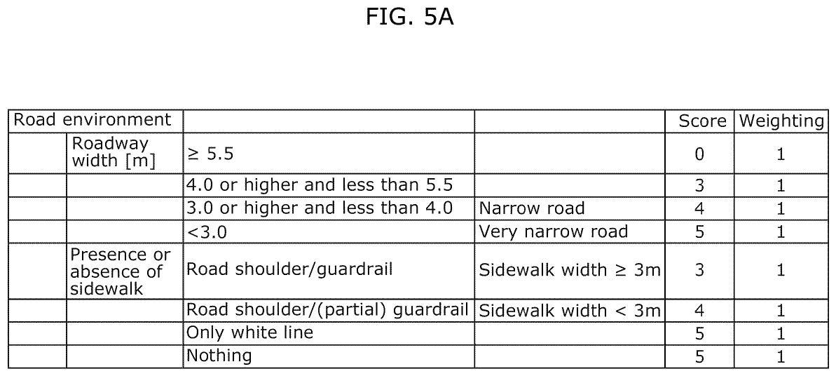

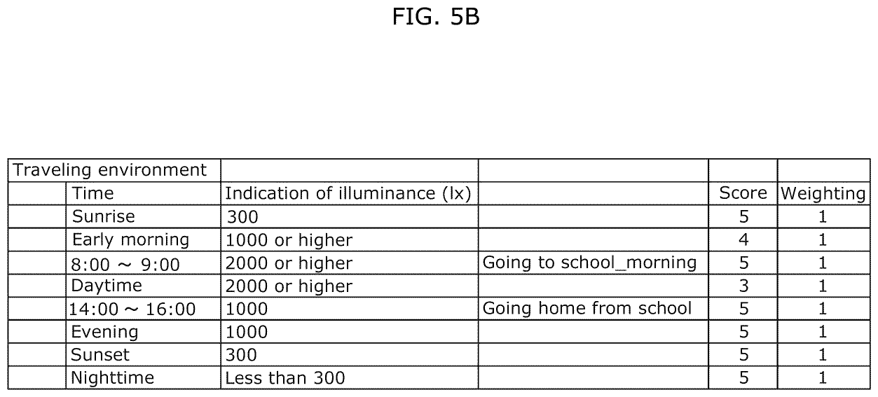

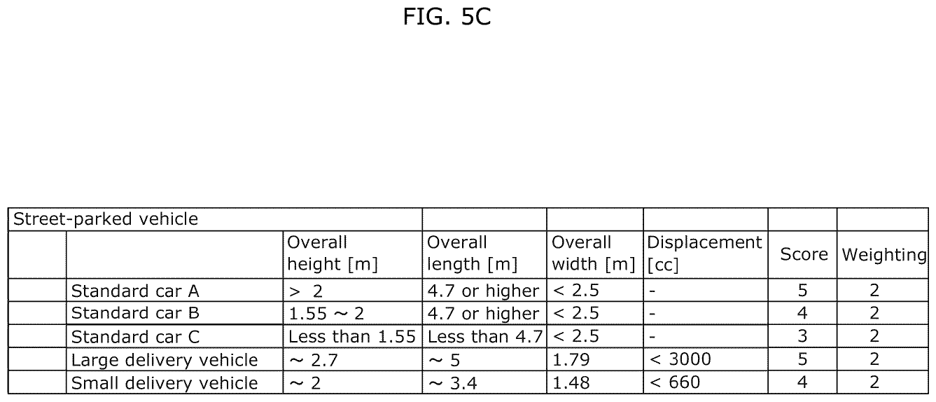

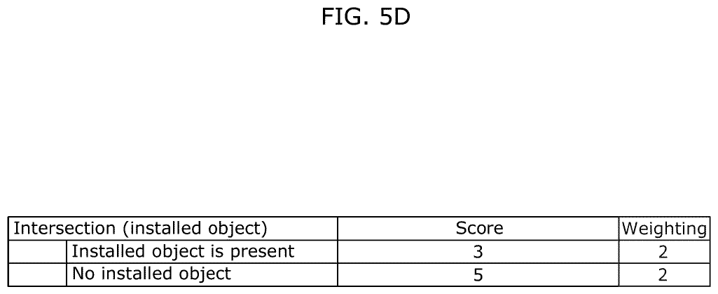

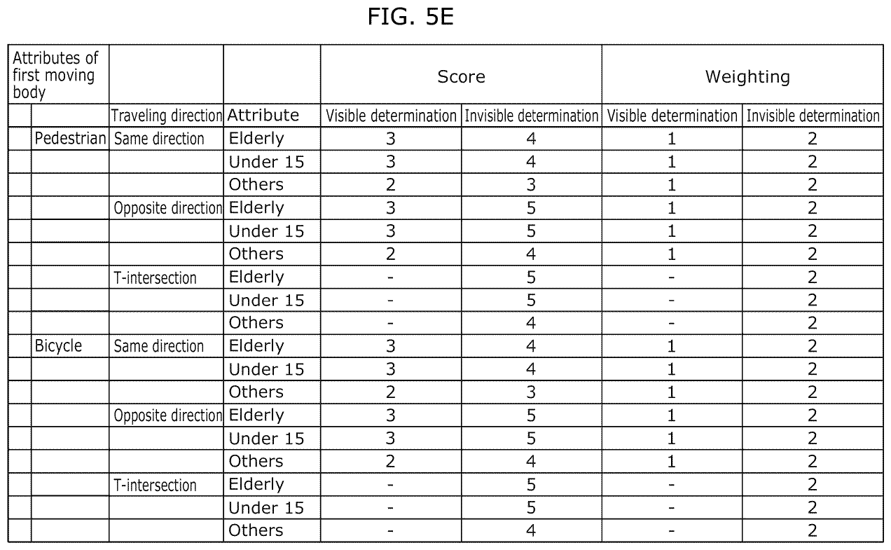

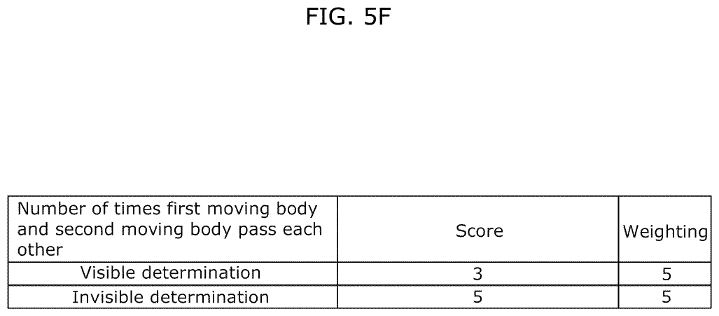

FIG. 1 is a block diagram illustrating hazard level determination system 1 that includes hazard level determination device 2. FIG. 2 illustrates a first moving body that includes first communication terminal 100 that emits signals and a second moving body that includes a plurality of second communication terminals 11. FIG. 3 illustrates states of a plurality of first moving bodies and a second moving body. In FIG. 3, (a) illustrates a state in which second communication terminals 11 of the second moving body obtain signals from first communication terminals 100 of first moving bodies P1 and P2. In FIG. 3, (b) illustrates a state in which the second moving body converges (e.g., overtakes or passes) the first moving bodies after an elapse of a predetermined period of time from the state in (a) of FIG. 3. FIG. 4 illustrates a relationship between time and distance in FIG. 3. FIG. 5A illustrates database of road environment. FIG. 5B illustrates database of traveling environment. FIG. 5C illustrates database of street-parked vehicles. FIG. 5D illustrates database of intersections. FIG. 5E illustrates database of attributes of first moving bodies. FIG. 5F illustrates database of the number of times first and second moving bodies pass each other. In the present embodiment, the signs “P1, P2, P3, P4”, etc. are omitted except when a specific one of the first moving bodies is indicated.

As illustrated in FIG. 1, hazard level determination system 1 is a system that is capable of notifying the user of the hazard level, taking into account the surrounding traffic environment, by recognizing first moving bodies traveling in the traffic area. Examples of the traffic area include a road (roadway and/or sidewalk) and an intersection on the road where moving bodies are capable of traveling. The hazard level is an indicator of the likelihood of a future collision or proximity between a second moving body and a first moving body obscured in a blind spot. For example, a higher hazard level is set to a child, who tends to act spontaneously and whose behavior is difficult to predict, and the elderly than to other age groups. Hazard level determination device 2 allows the user to be aware of future hazard levels by notifications to the user. The first moving bodies and the second moving body each are, for example, a vehicle such as a two-wheeler, a motorcycle, and an automobile, and a person carrying a mobile terminal.

The present embodiment illustrates an example where each first moving body is a pedestrian or a bicycle and the second moving body is a vehicle that includes hazard level determination device 2. In the present embodiment, the vehicle in which the user rides may be referred to as a second moving body, and the pedestrian or two-wheeler present around the second moving body may be referred to as a first moving body.

Hazard level determination system 1 includes first communication terminal 100 and hazard level determination device 2.

First communication terminal 100 is a communication device provided to each first moving body. First communication terminal 100 emits signals to the surrounding area of first communication terminal 100, so that second communication terminals 11 provided to the second moving body are capable of obtaining the signals. The signals are, for example, radio beacons and optical beacons. First communication terminal 100 and second communication terminals 11 may be capable of communicating with each other. The signals include the attributes of the first moving body that are registered in advance. The attributes of the first moving body indicate the features and properties of the first moving body, for example, “type of vehicle (first moving body) such as a two-wheeler, a motorcycle, and an automobile”, “presence or absence of electric motor”, “age group of person (first moving body) such as elderly, middle-aged, youth, adolescence, child, and infant carrying first communication terminal 100”, and “sex”. First communication terminal 100 is an example of a terminal.

First communication terminal 100 emits signals to the surrounding area of first communication terminal 100 to allow the second moving body to recognize the position, speed and direction of traveling of first communication terminal 100. By emitting signals at predetermined intervals to the surrounding area, first communication terminal 100 allows the second moving body to recognize the current position, speed, and direction of traveling of first communication terminal 100. First communication terminal 100 may be a communication device carried by, for example, a pedestrian or a bicycle that is the first moving body, may be a communication device that operates only when a vehicle is parked on the street, or may be attached to an object installed at an intersection.

Hazard level determination device 2 includes vehicle speed sensor 10, second communication terminals 11, illumination sensor 12, wiper-driving-state obtainer 13, in-vehicle communication device 14, in-vehicle camera 15, global positioning system (GPS) device 16, storage 17, calculator 20, and notifier 30.

Vehicle speed sensor 10 is a sensor that detects the traveling speed of the second moving body. Vehicle speed sensor 10 outputs information indicating the detected traveling speed of the second moving body to calculator 20.

As illustrated in FIG. 2, a plurality of second communication terminals 11 are provided to the second moving body. In the present embodiment, second terminal devices 11 are disposed at three positions that are at the center front end (back of the front bumper, etc.), front right end (right end of the bumper, right door mirror, etc.), and front left end (left end of the bumper, left door mirror, etc.) of the second moving body. The positions of second terminal devices 11 are not limited to the present embodiment, but may be disposed, for example, at the rear end of the vehicle (e.g., back of the rear bumper), the ceiling and the windshield of the second moving body. Each of the plurality of second communication terminals 11 is capable of receiving the signals emitted by first communication terminal 100. For example, when the plurality of second communication terminals 11 are connected to a plurality of antennas in a one-to-one correspondence, the plurality of second communication terminals 11 are capable of estimating different angles of arrivals A, B, and C of the signals emitted by first communication terminal 100 when receiving the signals due to the different positions of the antennas. The difference in the angle of arrival is derived from the phase difference of the signals received by the plurality of second communication terminals 11.

As illustrated in FIG. 1, the plurality of second communication terminals 11 receive the signals emitted by first communication terminal 100, and output information indicating the radio field strengths indicated by the signals and the attributes of the first moving body to calculator 20. The plurality of second communication terminals 11 may also be capable of emitting signals similar to the signals emitted by first communication terminal 100. Each second communication terminal 11 is an example of a communication terminal.

Each street-parked vehicle around the second moving body may transmit signals using, for example, an in-vehicle communication device. The street-parked vehicle may periodically transmit signals along with the parking brake and hazard lights when the vehicle becomes a street-parked vehicle. Here, the street-parked vehicle means a vehicle that is continuously stopped on the street, a vehicle that is stopped for loading or unloading a load for more than five minutes, or a vehicle that is stopped while the driver is away from the vehicle.

Illuminance sensor 12 is a sensor that detects the ambient illuminance of the second moving body. Illuminance sensor 12 outputs information indicating the detected ambient illuminance of the second moving body to calculator 20.

Wiper-driving-state obtainer 13 is an information obtainer that obtains the driving state of the wipers provided to the second moving body. Wiper-driving-state obtainer 13 outputs information indicating the driving state of the wipers of the second moving body to calculator 20.

In-vehicle communication device 14 is a communication device that obtains information indicating the driving environment around the second moving body. The information indicating the driving environment is, for example, the weather, amount of precipitation, and amount of rainfall in the area where the second moving body is located. In-vehicle communication device 14 outputs the information indicating the driving environment of the second moving body to calculator 20.

In-vehicle camera 15 is a camera sensor that detects information related to first moving bodies around the second moving body. The information related to the first moving bodies is, for example, the number of the first moving bodies around the second moving body. In-vehicle camera 15 outputs the information related to the first moving bodies to calculator 20.

GPS device 16 is a device that obtains information indicating the position of the second moving body. GPS device 16 outputs information indicating the position of the second moving body to calculator 20. GPS device 16 may further be capable of obtaining information indicating the traveling speed of the second moving body and the traveling direction of the second moving body.

Storage 17 is a memory that stores map information and the like. Storage 17 outputs map information in response to a request from calculator 20.

As illustrated in FIG. 3, calculator 20 is capable of, based on the signals emitted by first communication terminal 100 of each first moving body in the traffic area, estimating the position and the traveling speed of the first moving body, and determining the hazard level.

Calculator 20 includes state calculator 26 and hazard level determiner 24.

State calculator 26 is capable of estimating the position of the first moving body and the traveling speed of the first moving body by obtaining, from the plurality of second communication terminals 11, information such as the radio field strengths indicated by the signals emitted by first communication terminal 100 and the attributes of the first moving body.

For example, state calculator 26 is capable of estimating the distance between the second moving body and the first moving body based on the radio field strengths of the signals received by the plurality of second communication terminals 11. State calculator 26 may estimate the distance between the second moving body and the first moving body by obtaining, from first communication terminal 100, the round-trip time between first communication terminal 100 and each second communication terminal 11.

Since there is only one signal radiation source (first communication terminal 100), state calculator 26 is capable of estimating the angle of arrival of each signal relative to the traveling direction of the second moving body. In other words, state calculator 26 is capable of estimating the angle of arrival of each signal by the phase difference in the received signals. For example, as illustrated in FIG. 2, state calculator 26 is capable of estimating the angle of arrival A for second communication terminal 11 positioned at the center front end of the second moving body, the angle of arrival B for second communication terminal 11 positioned at the front right end of the second moving body, and the angle of arrival C for second communication terminal 11 positioned at the front left end of the second moving body. The different positions of the plurality of second communication terminals 11 lead to different angles of arrival of the respective signals. The traveling direction of the second moving body may be obtained from, for example, an electronic control unit (ECU) or a GPS sensor provided to the second moving body.

Since each second communication terminal 11 obtains signals from first communication terminal 100 at predetermined time intervals, state calculator 26 is capable of estimating the position of the first moving body based on the estimated distance between the second moving body and the first moving body and the estimated angle of arrival of the signal from the first moving body. When the position of the first moving body, as indicated by the angle of arrival and the like, is outside the traffic area, second communication terminal 11 is considered to be receiving reflected waves reflected by a surrounding structural object, so state calculator 26 may estimate the position of the first moving body from the reflected position. State calculator 26 may also estimate the position of the first moving body by obtaining, via some of the plurality of second communication terminals 11, the signals emitted by first communication terminal 100. For example, state calculator 26 may estimate the position of the first moving body by employing the signal with the highest radio field strength or the signal having a radio field strength that is higher than or equal to a predetermined value.

State calculator 26 also estimates the traveling speed of the first moving body according to temporal changes in the positions of the first moving body and the second moving body. The signals described above may include information indicating the traveling speed of the first moving body.

State calculator 26 is capable of indicating the position of the first moving body on the map information and the traveling speed of the first moving body based on the map information in storage 17 and the estimated position and traveling speed of the first moving body.

State calculator 26 is further capable of calculating the time required for the second moving body to converge, that is overtake, the first moving body or pass the first moving body, based on the estimated position and traveling speed of the first moving body and the position and the traveling speed of the second moving body.

The calculated time can be expressed as indicated in FIG. 4. FIG. 4 illustrates a relationship between the time required for the second moving body to pass first moving body P1, the time required for the second moving body to overtake first moving body P2, the distance between the converging point and the first moving body, and the distance between the converging point and the second moving body. The point in time (a) in FIG. 3 is indicated by the dashed line in FIG. 4. The traveling speeds of first moving body P1 and P2 and the traveling speed of the second moving body are represented by arrows from first moving bodies P1 and P2 and the second moving body toward the converging point.

More specifically, state calculator 26 includes first determiner 21, second determiner 22, street-parked vehicle identifier 25, and third determiner 23.

As illustrated in FIG. 1, first determiner 21 is capable of determining whether the second moving body will overtake or pass the first moving body, based on the information indicating the time calculated by state calculator 26, the estimated position of the first moving body, and the estimated traveling speed of the first moving body. When first determiner 21 determines that the second moving body will overtake or pass the first moving body that is present in front of the second moving body in the near future, first determiner 21 calculates the time required for the second moving body to overtake or pass the first moving body, and outputs, to hazard level determiner 24, information indicating the time required for the second moving body to overtake or pass the first moving body. When first determiner 21 determines that the second moving body will not overtake or pass the first moving body, the processes are repeated again. The near future is, for example, a few tens of seconds or a few seconds later.

Second determiner 22 recognizes an obstacle and the position of the obstacle along the traffic area based on map information, and identifies a blind spot where a first moving body is obscured by the obstacle, based on the attributes of the recognized obstacle, the position of the obstacle, and information indicating the position of the second moving body obtained from GPS device 16. Examples of the obstacle include buildings and installed objects that are not shown on the map and street-parked vehicles that emit signals similar to the first moving body. Second determiner 22 may identify each blind spot based on, for example, map information, the images obtained by in-vehicle camera 15, and the signals transmitted by the first moving body.

Second determiner 22 is capable of determining whether the first moving body is obscured in the identified blind spot, based on the identified blind spot, the information indicating the estimated position of the first moving body, the information indicating the estimated traveling speed of the first moving body, the information indicating the position of the second moving body, and the traveling speed of the second moving body. In other words, second determiner 22 performs “visible determination” meaning that the first moving body is determined not to be obscured in the blind spot and “invisible determination” meaning that the first moving body is determined to be obscured in the blind spot. When second determiner 22 determines that the first moving body is obscured in the blind spot, second determiner 22 calculates the time required for the second moving body to overtake or pass the first moving body obscured in the blind spot, and outputs, to hazard level determiner 24, information indicating the time required for the second moving body to overtake or pass the first moving body. When second determiner 22 determines that the first moving body is not obscured in the blind spot, second determiner 22 outputs, to hazard level determiner 24, the time required for the second moving body to overtake or pass the first moving body.

Street-parked vehicle identifier 25 is capable of identifying the presence of a street-parked vehicle parked on the street in the traveling direction of the second moving body, based on information related to the first moving body obtained from in-vehicle camera 15, information indicating the position of the second moving body obtained from GPS device 16, and map information obtained from storage 17. Street-parked vehicle identifier 25 outputs, to hazard level determiner 24, that a street-parked vehicle is present.

In the present embodiment, the street-parked vehicle may emit signals similarly to the first moving body. In this case, the second moving body is capable of obtaining the signals emitted by the street-parked vehicle. The signal transmitted from the street-parked vehicle includes attributes of the street-parked vehicle. The attributes of the street-parked vehicle indicate features and properties, such as “size of the vehicle such as large, medium, or small vehicle”, “height”, “overall length”, “overall width”, and “position of the first communication terminal”.

Regardless of the presence or absence of blind spots, third determiner 23 is capable of determining whether the traveling speed of the second moving body has changed after the time required for the second moving body to overtake or pass the first moving body is calculated, based on the information indicating the traveling speed of the second moving body obtained from vehicle speed sensor 10.

For example, when third determiner 23 determines that the traveling speed of the second moving body has changed, third determiner 23 again calculates the time required for the second moving body to overtake or pass the first moving body, based on the determination result, the estimated position and traveling speed of the first moving body, and the position and the traveling speed of the second moving body after the speed change. Third determiner 23 then outputs, to hazard level determiner 24, the time required for the second moving body to overtake or pass the first moving body which has been calculated again.

When third determiner 23 determines that the traveling speed of the second moving body has not changed, third determiner 23 outputs, to hazard level determiner 24, the time required for the second moving body to overtake or pass the first moving body.

Hazard level determiner 24 is capable of determining the hazard level of the first moving body for the second moving body, based on, for example, information indicating the time required for the second moving body to overtake or pass the first moving body, information indicating the presence of a street-parked vehicle (information indicating the estimated position of the first moving body), and information indicating the estimated traveling speed of the first moving body, that is, based on the calculation results of state calculator 26. The hazard level is an indicator of the degree of likelihood that the second moving body will collide or come into close proximity with the first moving body in the near future.

Hazard level determiner 24 is further capable of determining the hazard level of the first moving body for the second moving body by further taking into account information indicating the ambient illuminance of the second moving body detected by illuminance sensor 12, information indicating the driving state of the wipers of the second moving body obtained by wiper-driving-state obtainer 13, and information indicating the traveling environment of the second moving body obtained by in-vehicle communication device 14. Hazard level determiner 24 outputs the determined hazard level to notifier 30.

Examples of notifier 30 include sound unit 31 such as a loudspeaker provided to the second moving body, display unit 32 such as a monitor provided to the second moving body, and vibrator 33 that transmits vibrations to the user. Notifier 30 notifies, for example, the result of the determination made by first determiner 21, second determiner 22, or third determiner 23, which is “the time required for the second moving body to overtake or pass the first moving body”, the “hazard level” determined by hazard level determiner 24, or the “occurrence of a blind spot caused by the presence of a street-parked vehicle” identified by street-parked vehicle identifier 25.

Moreover, hazard level determination system 1 that includes hazard level determination device 2, the hazard level determination method, and the program according to the present embodiment may also determine the hazard level according to a weighting corresponding to the surrounding environment of the vehicle.

For example, storage 17 may store a database for hazard level determiner 24 to determine the hazard level. The surrounding environment of the vehicle includes, for example, the road environment in the traffic area, the driving environment in the traffic area, street-parked vehicles parked in the traffic area, the presence or absence of installed objects at intersections, attributes of each first moving body, and the number of times the first moving bodies and the second moving body pass each other.

As illustrated in FIG. 5A, the road environment includes “roadway width” and “presence or absence of sidewalk”, and is included in the map information. For the “roadway width”, the narrower the roadway, the higher the score. For the “presence or absence of sidewalk”, the narrower the sidewalk, the higher the score. For the road environment, “1” is set to all weightings. For the road environment, the weighting values may be increased for bad weather conditions, such as snowfall or heavy rain.

As illustrated in FIG. 5B, the traveling environment includes a “time” of the day, and the “time” is associated with an “indication of illuminance”. The “time” includes, for example, sunrise, early morning, 8:00 to 9:00, daytime, 14:00 to 16:00, evening, sunset, and nighttime. The “indication of illuminance” includes 300 lx at sunrise, 1000 lx or higher in the early morning, 2000 lx or higher between 8:00 and 9:00, 2000 lx or higher at daytime, 1000 lx between 14:00 and 16:00, 1000 lx in the evening, 300 lx at sunset, and less than 300 lx at nighttime. The score of “4” is set to the early morning, the score of “3” is set to the daytime, and the score of “5” is set to the others. In the traveling environment, “1” is set to all weightings. In the traveling environment, the weighting values may be increased for bad weather conditions, such as snowfall or heavy rain.

As illustrated in FIG. 5C, the street-parked vehicle includes the vehicle types “standard car” and “delivery car” which are associated with “overall height”, “overall length”, “overall width”, and “displacement”. For the “standard car”, the higher the “overall height” and the longer the “overall length”, the higher the score. For delivery vehicles, too, the higher the “overall height”, the longer the “overall length” and “overall width”, and the larger the “displacement”, the higher the score. For the street-parked vehicle, “2” is set to all weightings.

As illustrated in FIG. 5D, the presence or absence of installed objects at intersections includes “Yes” for when an installed object is present and “No” for when an installed object is absent. A lower score is set to “Yes” than to “No”. For the presence or absence of installed objects at intersections, “2” is set to all weightings.

As illustrated in FIG. 5E, the attributes of the first moving body include “pedestrian” and “bicycle” which are associated with the “traveling direction” and the “attributes of the first moving body”. The “traveling direction” includes “same direction”, “opposite direction”, and “T-intersection,” and the “attributes” includes “elderly”, “under 15” and “others”. The scores and weightings include the “visible determination” meaning that the first moving body is determined not to be obscured in a blind spot, and the “invisible determination” meaning that the first moving body is determined to be obscured in a blind spot. The “visible determination” is set to have a lower score and less weighting than the “invisible determination”. A lower score is set to the “others” of the “attributes” than to the “elderly” and “under 15”. “1” is set to all weightings for the “visible determination”, and “2” is set to all weightings for the “invisible determination”.

As illustrated in FIG. 5F, the number of times the first moving bodies and the second moving body pass each other includes the “visible determination” and “invisible determination”. A lower score is set for the “visible determination” than for the “invisible determination”. “5” is set to all weightings for both the “visible determination” and “invisible determination”.

When determining the hazard level, hazard level determiner 24 is capable of using the database in storage 17 to calculate the total score. The total score is calculated by summing each “score” multiplied by the “weighting”. Hazard level determiner 24 may determine that the hazard level is high when the total score is higher than or equal to a predetermined threshold value. Notifier 30 may also adjust, for example, the color of the notification to the user or the size of the texts for the notification according to the scores.

The above scores and weightings are examples only, and are not limited to the present embodiment.

### Operation

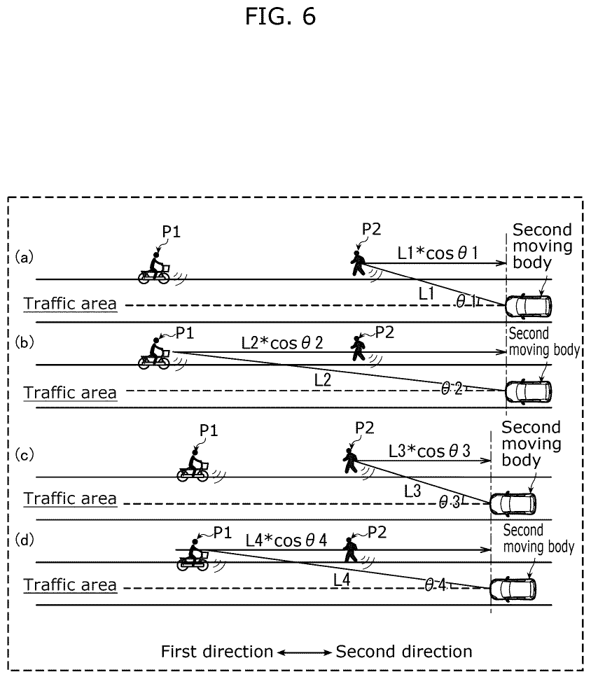

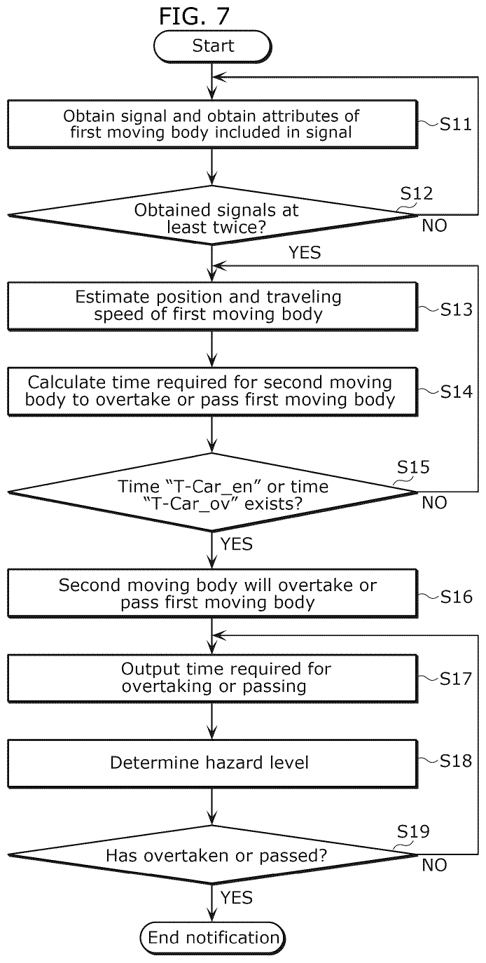

An operation example of hazard level determination system 1 that includes hazard level determination device 2, the hazard level determination method, and the program will be described with reference to FIG. 6 and FIG. 7.

FIG. 6 illustrates states of a plurality of first moving bodies and a second moving body in a traffic area. FIG. 7 is a flowchart illustrating an operation example of hazard level determination device 2.

In FIG. 6, (a) illustrates the time when each second communication terminal 11 of a second moving body receives a signal from first communication terminal 100 of first moving body P2. In FIG. 6, (b) illustrates the time when each second communication terminal 11 of the second moving body receives a signal from first communication terminal 100 of first moving body P1. In FIG. 6, (c) illustrates the time when each second communication terminal 11 of the second moving body receives a next signal from first communication terminal 100 of first moving body P2 after the time in (a) of FIG. 6. In FIG. 6, (d) illustrates the time when each second communication terminal 11 of the second moving body receives a next signal from first communication terminal 100 of first moving body P1 after the time in (b) of FIG. 6. FIG. 6 and FIG. 7 illustrate an example where the second moving body and first moving bodies P1 and P2 that are present in the traveling direction of the second moving body are present in a traffic area. It is assumed that first moving body P2 and the second moving body are traveling in the same first direction, and first moving body P1 is facing the second moving body and traveling in the second direction opposite to the first direction.

First, as illustrated in FIG. 7, state calculator 26 obtains the signals emitted by first communication terminal 100 via the plurality of second communication terminals 11, and obtains the attributes of the first moving body included in the signals (S11).

Next, state calculator 26 determines whether the signals emitted by first communication terminal 100 have been obtained at least twice within a predetermined period (S12). When state calculator 26 determines that the signals emitted by first communication terminal 100 have not been obtained at least twice within the predetermined period (No in S12), hazard level determination device 2 returns the process to step S11. Here, the predetermined period is, for example, a predetermined period of time, such as one second or several seconds.

On the other hand, when state calculator 26 determines that the signals emitted by first communication terminal 100 have been obtained at least twice within the predetermined period (Yes in S12), state calculator 26 estimates the position and the traveling speed of the first moving body (S13).

Specifically, state calculator 26 estimates the distance between the second moving body and the first moving body and the angle of arrival of each signal relative to the traveling direction of the second moving body, based on the first signal emitted by first communication terminal 100. State calculator 26 further obtains information indicating the attributes of the first moving body included in the signal. Next, state calculator 26 estimates the position of the first moving body and the distance between the second moving body and the first moving body based on the subsequent signal emitted by first communication terminal 100.

State calculator 26 may estimate, as the position of the first moving body and the distance between the second moving body and the first moving body, the average value of the positions of the first moving body and the average value of the distances between the second moving body and the first moving body estimated based on the signals obtained three or more times within the predetermined period. State calculator 26 may also estimate the position of the first moving body and the distance between the second moving body and the first moving body, based on the two signals most recently obtained.

Next, when first determiner 21 determines that the second moving body will overtake or pass the first moving body that is present in front of the second moving body, state calculator 26 calculates the time required for the second moving body to overtake or pass the first moving body, based on the estimated position and the traveling speed of the first moving body and the position and the traveling speed of the second moving body (S14).

As illustrated in (a) and (b) of FIG. 3, the time required for first moving body P1 and the second moving body to pass each other, referred to as “T-VRU”, is calculated as (L1−L2)/(V1+V2), where L1 is the distance between first moving body P1 and the second moving body, L2 is the distance between the converging point (overtaking or passing point) and the second moving body, V1 is the traveling speed of first moving body P1, V2 is the traveling speed of first moving body P2, and V is the traveling speed of the second moving body. Additionally, the time required for first moving body P1 and the second moving body to pass each other, referred to as “T-Car_en”, is calculated as L1/(V+V1), and the time required for the second moving body to overtake first moving body P2, referred to as “T-Car_ov”, is calculated as L2/(V−V2).

In (b) and (d) of FIG. 6, the time required for the second moving body to pass first moving body P1, referred to as “T-Car_en”, is calculated as L4×cos θ4 /(V1+V).

In this case, (V+V1)=V+(L2×cos θ2−L4×cos θ4+V×transmission period)/transmission period. Here, in (b) of FIG. 6, L2 is the straight-line distance between first moving body P1 and the second moving body, and θ2 is the angle between the straight line connecting the first and second moving bodies and the traveling direction of the second moving body. In (d) of FIG. 6, L4 is the straight-line distance between first moving body P1 and the second moving body, and θ4 is the angle between the straight line connecting the first and second moving bodies and the traveling direction of the second moving body.

In (a) and (c) of FIG. 6, the time required for the second moving body to overtake first moving body P2, referred to as “T-Car_ov”, is calculated as L3×cos θ3/(V−V2).

In this case, (V−V2)=V−(L3×cos θ3+V×transmission period−L1×cosθ1)/transmission period. In (c) of FIG. 6, L3 is the straight-line distance between first moving body P2 and the second moving body, and θ3 is the angle between the straight line connecting first moving body P2 and the second moving body and the traveling direction of the second moving body. In (a) of FIG. 6, L1 is the straight-line distance between first moving body P2 and the second moving body, and θ1 is the angle between the straight line connecting first moving body P2 and the second moving body and the traveling direction of the second moving body.

Additionally, three times are calculated: the time required for first moving body P1 and the second moving body to pass each other, “T-VRU”; the time required for the second moving body to pass first moving body P1, “T-Car_en”; and the time required for the second moving body to overtake first moving body P2, “T-Car_ov”. When the time differences between “T-VRU” and “T-Car_ov”, “T-VRU” and “T-Car_en”, or “T-Car_ov” and “T-Car_en” are equal to or below a certain threshold value, first moving bodies P1, P2, and the second moving body are considered to pass each other nearly simultaneously. The threshold value can be, for example, 0.5 milliseconds.

Note that, strictly, distance L1 is the distance between first communication terminal 100 of first moving body P1 and each second communication terminal 11 of the second moving body, and distance L2 is the distance between the converging point and each second communication terminal 11 of the second moving body. However, in the present embodiment, first moving bodies P1 and P2 and the second moving body may be used for description.

The present embodiment illustrates an example where distances L1 to L4 are replaced by the distance between the first moving body and the second moving body arranged on the same straight line.

Next, as illustrated in FIG. 7, state calculator 26 determines whether the time “T-Car_en” or time “T-Car_ov” exists (S15). When state calculator 26 determines that time “T-Car_en” and time “T-Car_ov” do not exist (No in S15), hazard level determination device 2 returns the process to step S13, but may return the process to step S11.

On the other hand, when state calculator 26 determines that time “T−Car_en” or time “T−Car_ov” exists (Yes in S15), state calculator 26 estimates that the second moving body will overtake or pass the first moving body, based on information indicating the time required for the second moving body to overtake or pass the first moving body, information indicating the presence of a street-parked vehicle (information indicating the estimated position of the first moving body), and the estimated traveling speed of the first moving body (S16).

State calculator 26 outputs the time required for the second moving body to overtake or pass the first moving body to hazard level determiner 24 (S17). Hazard level determination device 24 notifies notifier 30 of the time required for the second moving body to overtake or pass the first moving body. This allows the user of the second moving body to recognize the time.

Next, hazard level determiner 24 determines the hazard level of the first moving body for the second moving body (S18) based on information indicating the time required for the second moving body to overtake or pass the first moving body, information indicating the presence of a street-parked vehicle (information indicating the estimated position of the first moving body), and the estimated traveling speed of the first moving body. Hazard level determiner 24 outputs the determined hazard level to notifier 30. Notifier 30 notifies the user of the second moving body of the hazard level of the first moving body for the second moving body. This allows the user of the second moving body to recognize the hazard level.

FIG. 3 and FIG. 4 illustrate an example where three moving bodies that are first moving bodies P1 and P2 and the second moving body will pass and overtake at the same time at the converging point. In this case, the hazard level is assumed to be high. Thus, for example, first determiner 21 may notify the user via hazard level determiner 24 and notifier 30 that the traveling speed of the second moving body is to be changed (to be decelerated in the present embodiment) so that the second moving body will overtake first moving body P2 after the second moving body passes first moving body P1.

Thus, the user is able to change the traveling speed of the second moving body to avoid collision or proximity with first moving bodies P1 and P2. For example, as indicated by the dash-dot-dot arrows in FIG. 4, the second moving body is decelerated, which delays the arrival of the second moving body at the converging point. Therefore, it is possible to prevent first moving bodies P1 and P2 and the second moving body from simultaneously overtaking and passing each other at the converging point.

Next, first determiner 21 determines whether the second moving body has overtaken or passed the first moving body (S19). In other words, first determiner 21 performs the determination in step S19 until the time required for the second moving body to overtake or pass the first moving body becomes zero. When first determiner 21 determines that the second moving body has not overtaken or passed the first moving body (No in S19), hazard level determination device 2 returns the process to step S17.

On the other hand, when first determiner 21 determines that the second moving body has overtaken or passed the first moving body (Yes in S19), hazard level determination device 2 ends the processes in the flowchart of FIG. 7. Hazard level determination device 2 may return the process to step S11 and repeat the processes in the flowchart of FIG. 7.

Note that the traveling speeds of the first moving body and the second moving body are considered to change over time. However, because the processes in the flowchart of FIG. 7 are repeatedly performed, even when the traveling speeds of the first moving body and the second moving body change over time, the hazard level can be determined in real time according to the changes.

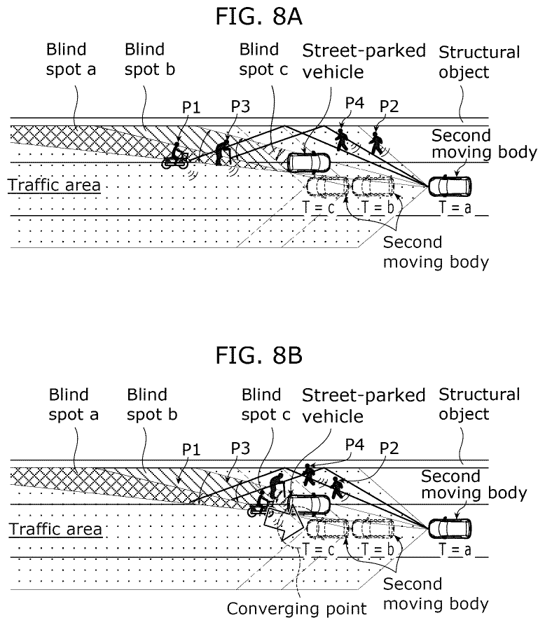

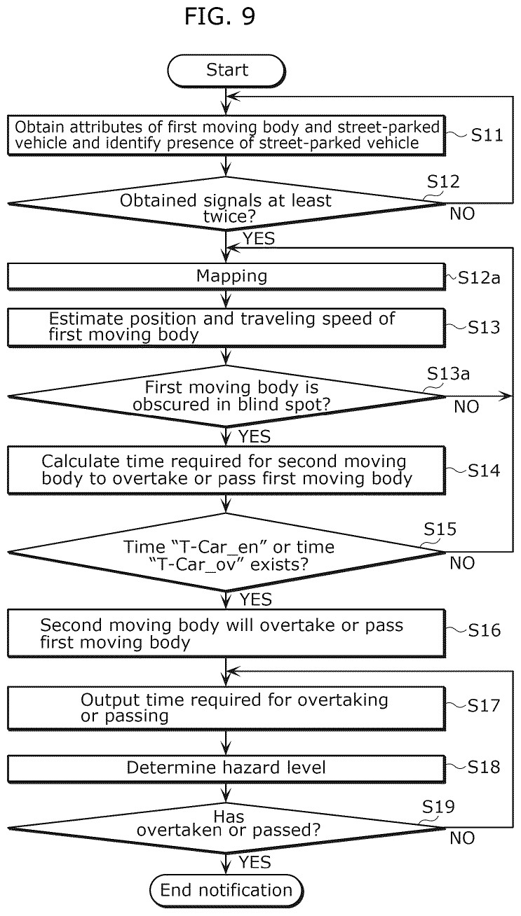

Another operation example of hazard level determination system 1 that includes hazard level determination device 2, the hazard level determination method, and the program will be described with reference to FIG. 8A to FIG. 9.

The processes that are identical to those in FIG. 7 are marked with the same reference numerals and the descriptions thereof are omitted as appropriate.

FIG. 8A illustrates states of a plurality of first moving bodies and a second moving body when an obstacle is present in a traffic area. FIG. 8B illustrates states of the plurality of first moving bodies and the second moving body after an elapse of time from the state in FIG. 8A. In FIG. 8A and FIG. 8B, the time when each second communication terminal 11 of the second moving body first received a signal is indicated as T=a, the time when second communication terminal 11 of the second moving body received a signal after a predetermined period is indicated as T=b, and the time when second communication terminal 11 of the second moving body received a signal after another predetermined period is indicated as T=c. The blind spots formed by an obstacle when T=a are indicated by blind spot a (grid-like hatching), blind spot b (negatively sloped hatching), and blind spot c (positively sloped hatching). The blind spots formed by an obstacle when T=b are indicated by blind spot b (negatively sloped hatching) and blind spot c (positively sloped hatching). The blind spot formed by an obstacle when T=c is indicated by blind spot c (positively sloped hatching). FIG. 9 is a flowchart illustrating an operation example of hazard level determination device 2 when an obstacle is present in the traffic area.

A street-parked vehicle is present in the traffic area in each of FIG. 8A and FIG. 8B. FIG. 8A and FIG. 8B illustrate straight roads and each assume a traffic area with blind spots formed by a street-parked vehicle parked on the straight road. For example, in each of FIG. 8A and FIG. 8B, blind spots are formed by the street-parked vehicle, making it difficult for the second moving body to visually recognize first moving bodies P1 and P3 obscured in the blind spots.

The street-parked vehicle includes first communication terminal 100. Each signal emitted by first communication terminal 100 included in the street-parked vehicle includes the attributes of the street-parked vehicle.

In this case, when the signal emitted by first communication terminal 100 of the first moving body is a radio beacon, the signal is reflected by a structural object such as a wall or facility located along the traffic area. Thus, each second communication terminal 11 is capable of receiving the signal emitted by first communication terminal 100.

First, state calculator 26 obtains, from the plurality of second communication terminals 11, the signals emitted by first communication terminal 100, and obtains the attributes of the first moving body included in the signals. State calculator 26 further obtains the signals emitted by first communication terminal 100 of the street-parked vehicle from the plurality of second communication terminals 11, and obtains the attributes of the street-parked vehicle included in the signals. Street-parked vehicle identifier 25 identifies the presence of a street-parked vehicle parked in the traveling direction of the second moving body, based on information related to the first moving body obtained from in-vehicle camera 15, information indicating the position of the second moving body obtained from GPS device 16, and map information obtained from storage 17 (S11).

Next, after step S12, state calculator 26 estimates the position of the street-parked vehicle based on the signal obtained from the street-parked vehicle and further performs mapping the position of the street-parked vehicle on the map information (S12a). According to the present embodiment, it is possible to estimate the position of the street-parked vehicle without including a camera and a radar in the second moving body. In other words, according to the present embodiment, it is possible to operate as a separate system from an advanced driver assistance system (ADAS) which is capable of calculating the position by using a camera and a radar. Therefore, hazard level determination device 2 is useful as a fail-safe function for ADAS. State calculator 26 may obtain information related to the first moving body from in-vehicle camera 15, information indicating the position of the second moving body from GPS device 16, and map information from storage 17, and perform mapping the position of the second moving body and the position of the first moving body around the second moving body on the map information.

Next, after step S13, second determiner 22 obtains the attributes of the street-parked vehicle from the signal obtained from the street-parked vehicle parked in the traffic area. Second determiner 22 then identifies a blind spot where the first moving body is obscured by the street-parked vehicle, based on the attributes of the street-parked vehicle included in the signal, the information indicating the position of the street-parked vehicle, and information indicating the position of the second moving body. Second determiner 22 determines whether the first moving body is obscured in the identified blind spot, based on the identified blind spot, information indicating the estimated position of the first moving body, information indicating the estimated traveling speed of the first moving body, information indicating the position of the second moving body, and information indicating the traveling speed of the second moving body (S13a).

When there is no first moving body obscured by the street-parked vehicle, second communication terminals 11 cannot receive signals. Therefore, state calculator 26 is capable of determining that there is no first moving body obscured by the street-parked vehicle (No in S13a). In this case, hazard level determination device 2 returns the process to step S12a.

On the other hand, when second communication terminal 11 obtains the signal emitted by first communication terminal 100, state calculator 26 is capable of determining that a first moving body obscured by the street-parked vehicle exists (Yes in S13a).

Next, after steps S14 to S19, the processes in the flowchart in FIG. 9 end. When No is made in S15, hazard level determination device 2 returns the process to S12a. Hazard level determination device 2 may return the process to step S11 and repeat the processes in the flowchart in FIG. 9.

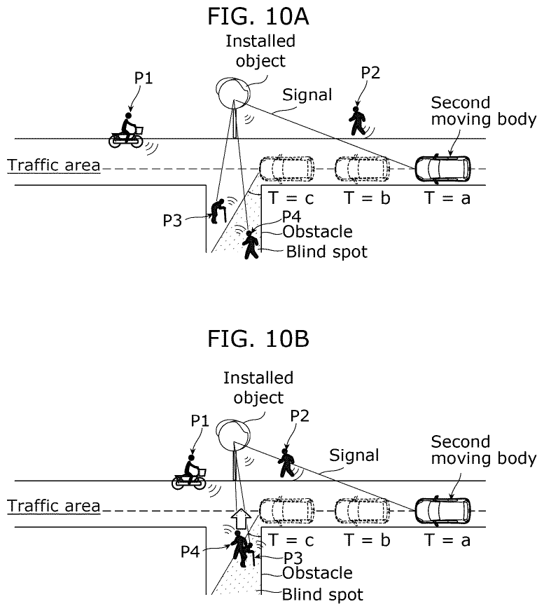

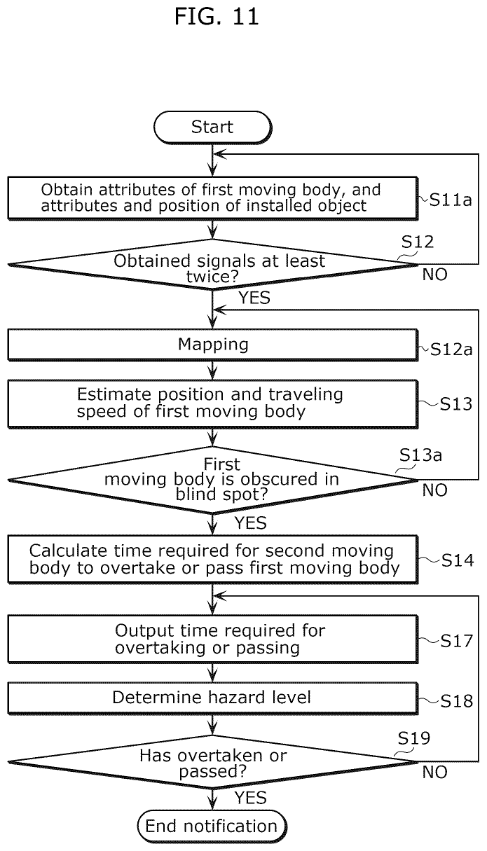

Furthermore, with reference to FIG. 10A to FIG. 11, another operation example of hazard level determination system 1 that includes hazard level determination device 2, the hazard level determination method, and the program will be described.

The processes that are identical to those illustrated in the operation example in FIG. 9 are marked with the same reference numerals and the descriptions thereof will be omitted as appropriate.

FIG. 10A illustrates states of a plurality of first moving bodies and a second moving body at an intersection with a blind spot. FIG. 10B illustrates states of the plurality of first moving bodies and the second moving body after an elapse of time from the state in FIG. 10A. FIG. 11 is a flowchart illustrating an operation example of hazard level determination device 2 when the traffic area includes a blind spot.

The traffic area in each of FIG. 10A and FIG. 10B includes an installed object. The installed object is, for example, a curve mirror installed in the traffic area. The traffic area in each of FIG. 10A and FIG. 10B assumes a traffic area that includes an intersection such as a T-intersection or crossroad where a blind spot is formed by an obstacle such as a wall or facility and an installed object, such as a curve mirror, installed at the intersection. In each of FIG. 10A and FIG. 10B, the obstacle forms a blind spot, and the first moving body obscured in the blind spot cannot be visually recognized from the second moving body.

Each installed object includes first communication terminal 100. The signal emitted by first communication terminal 100 provided to the installed object includes the attributes of the installed object. The attributes of the installed object indicate the features and properties of the installed object, such as the size of the installed object, the function of the installed object (number of mirrors for a curve mirror), the height of the installed object, and the orientation of the installed object.

In this case, the signal emitted by first communication terminal 100 of the first moving body is reflected by an installed object such as a curve mirror or a surrounding exterior wall. Therefore, each second communication terminal 11 is capable of receiving the signal emitted by first communication terminal 100.

First, state calculator 26 obtains the signals emitted by first communication terminal 100 from the plurality of second communication terminals 11, and obtains the attributes of the first moving body included in the signals. State calculator 26 further obtains the signals emitted by first communication terminal 100 of the installed object in the traffic area from the plurality of second communication terminals 11, and obtains the attributes and the position of the installed object included in the signals (S11a).

Next, after steps S12 to S13, second determiner 22 recognizes an obstacle located along the traffic area and the position of the obstacle based on the map information. Second determiner 22 may recognize one or more obstacles located along the traffic area from in-vehicle camera 15. Based on the attributes of the recognized obstacle, information indicating the position of the obstacle, and information indicating the position of the second moving body, second determiner 22 identifies a blind spot where the first moving body is obscured by the obstacle. Second determiner 22 may further identify a blind spot where the first moving body is obscured by an obstacle, taking into account the traveling direction of the second moving body.

Second determiner 22 determines whether the first moving body is obscured in the identified blind spot, based on the identified blind spot, the information indicating the estimated position of the first moving body, the information indicating the estimated traveling speed of the first moving body, the information indicating the position of the second moving body, and the information indicating the traveling speed of the second moving body (S13a).

When No is made in step S13a, hazard level determination device 2 returns the process to step S12a.

On the other hand, when Yes is made in S13a, state calculator 26 calculates the time required for the second moving body to overtake or pass the first moving body, based on the estimated position and traveling speed of the first moving body and the position and traveling speed of the second moving body (S14).

Next, after steps S17 to S19, the processes in the flowchart in FIG. 11 end. Hazard level determination device 2 may return the process to step S11 and repeat the processes in the flowchart of FIG. 11.

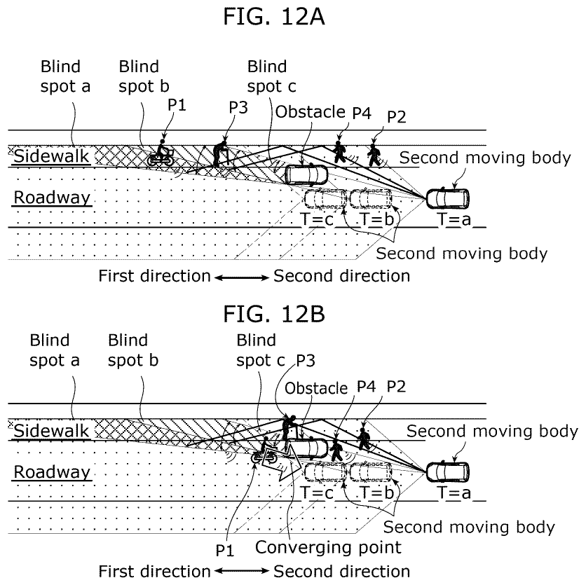

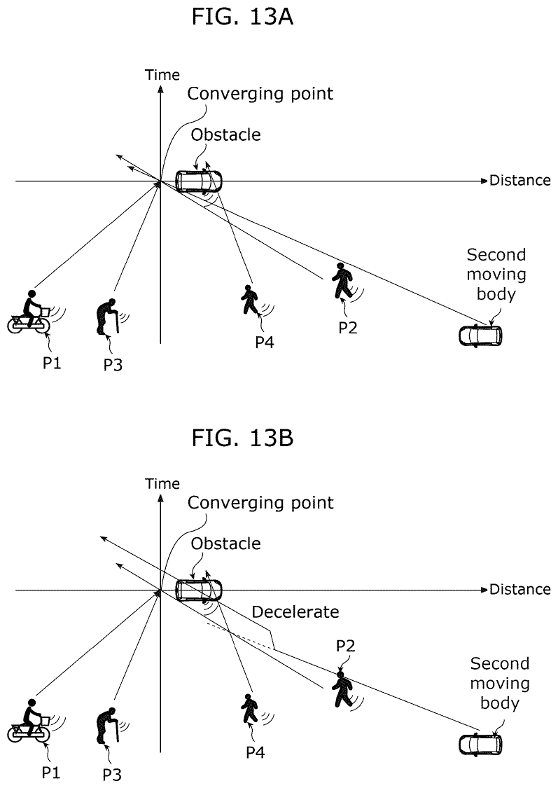

Furthermore, with reference to FIG. 12A to FIG. 13B, hazard level determination system 1 that includes hazard level determination device 2, the hazard level determination method, and the program will be described.

FIG. 12A illustrates states of a plurality of first moving bodies and a second moving body in a traffic area with a narrow sidewalk and an obstacle that is a street-parked vehicle. FIG. 12B illustrates states of the plurality of first moving bodies and the second moving body after an elapse of time from the state in FIG. 12A. In FIG. 12A and FIG. 12B, the time when each second communication terminal 11 of the second moving body first received a signal is indicated by T=a, the time when second communication terminal 11 received a signal after a predetermined period is indicated by T=b, and the time when second communication terminal 11 received a signal after another predetermined period is indicated by T=c. The blind spots formed by a street-parked vehicle when T=a are indicated by blind spot a (grid-like hatching), blind spot b (negatively sloped hatching), and blind spot c (positively sloped hatching). The blind spots formed by the street-parked vehicle when T=b are indicated by blind spot b (negatively sloped hatching) and blind spot c (positively sloped hatching). The blind spot formed by the street-parked vehicle when T=c is indicated by blind spot c (positively sloped hatching). FIG. 13A illustrates a relationship between time and distance for a plurality of first moving bodies and a second moving body. FIG. 13B illustrates a relationship between time and distance when the second moving body decelerates out of the plurality of first moving bodies and the second moving body.

FIG. 12A to FIG. 13B each assume that five moving bodies that are first moving bodies P1, P2, P3 and P4 and the second moving body, overtake and pass each other at the same time at the converging point. The traffic area in each of FIG. 12A to FIG. 13B includes a roadway and a sidewalk. On the sidewalk, first moving bodies P1 and P3 are traveling in the second direction and first moving bodies P2 and P4 are traveling in the first direction. First moving body P3 is present in front of first moving body P1, first moving body P4 is present in front of first moving body P2, and first moving body P2 is present in front of the second moving body. On the roadway, the second moving body is traveling in the first direction and a street-parked vehicle is parked in front of the second moving body. The attribute of first moving body P1 is a youth riding a bicycle, the attribute of first moving body P2 is a youth who is running, the attribute of first moving body P3 is an elderly person who is walking, and the attribute of first moving body P4 is a child who is walking. First moving body P3 is obscured in the blind spot formed by the street-parked vehicle on the roadway.

For example, it is assumed that first moving body P1 may move from the sidewalk to the roadway near the converging point to avoid first moving body P3 on the sidewalk. In this case, first moving body P1 may be obscured in a blind spot formed by the street-parked vehicle. In such cases, the hazard level is considered to be high. Therefore, first determiner 21 notifies the user, via hazard level determiner 24 and notifier 30, of the time required for the second moving body to overtake or pass first moving bodies P1, P2, P3, and P4 and that the traveling speed of the second moving body is to be changed (e.g., decelerated). As illustrated in FIG. 13B, this allows the user to change the traveling speed of the second moving body (in the present embodiment, decelerates the second moving body) to avoid collision or proximity with first moving bodies P1, P2, P3, and P4.

When first moving bodies P2 and P4 do not exist on the sidewalk, first moving body P1 is considered to continue traveling on the sidewalk. Therefore, first determiner 21 notifies the user, via hazard level determiner 24 and notifier 30, of the time required for the second moving body to overtake or pass first moving bodies P1 and P3, and does not notify the user that the traveling speed of the second moving body is to be changed (e.g. decelerated).

Moreover, for example, first moving bodies P2 and P4 may move from the sidewalk to the roadway near the converging point to avoid first moving body P3 on the sidewalk. In this case, the user of the second moving body is capable of directly visually recognizing first moving bodies P2 and P4. However, first moving body P1 may move from the sidewalk to the roadway near the converging point to avoid first moving body P3 on the sidewalk. This causes first moving body P1 to be obscured in the blind spot formed by the street-parked vehicle. Hence, it is difficult for the user of the second moving body to visually recognize first moving body P1. Therefore, first determiner 21 notifies the user, via hazard level determiner 24 and notifier 30, of the time required for the second moving body to overtake or pass first moving bodies P1, P2, P3, and P4 and that the traveling speed of the second moving body is to be changed (e.g., decelerated). With this, the user is capable of avoiding collision or proximity with first moving bodies P1, P2, P3, and P4 near the converging point by changing the traveling speed of the second moving body.

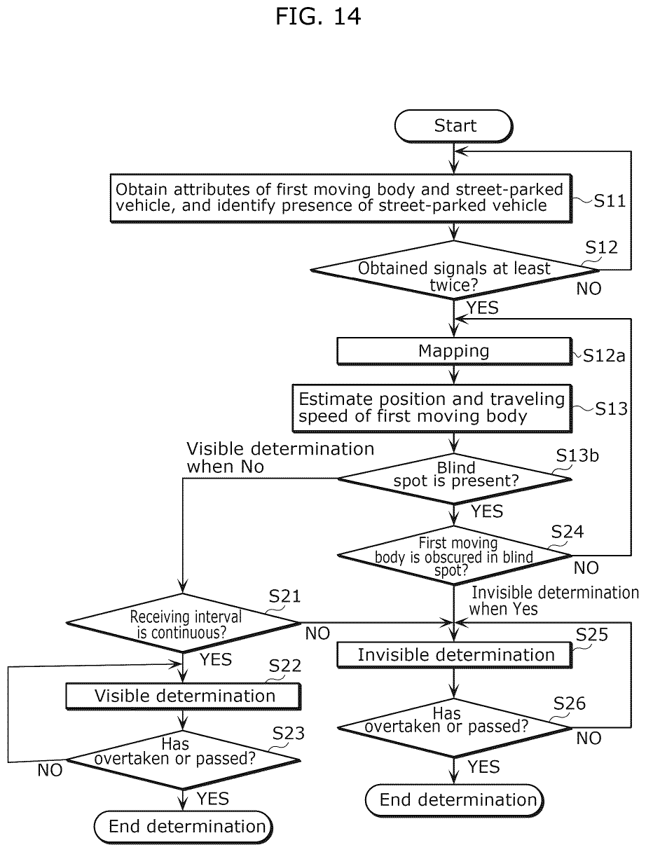

Another operation example of hazard level determination system 1 that includes hazard level determination device 2, the hazard level determination method, and the program will be described with reference to FIG. 14.

FIG. 14 is another flowchart illustrating an operation example of hazard level determination device 2 when a blind spot is present in the traffic area.

The processes that are identical to those in the operation example illustrated in FIG. 9 are marked with the same reference numerals and the descriptions thereof are omitted as appropriate.

First, after steps S11, S12, S12a, and S13, second determiner 22 obtains the attributes of the street-parked vehicle from the signal obtained from the street-parked vehicle parked in the traffic area, and identifies a blind spot where the first moving body is obscured by the street-parked vehicle, based on the attribute of the street-parked vehicle included in the signal. In other words, second determiner 22 determines whether “visible determination” is to be made or a blind spot for which “invisible determination” is to be made is present, based on the attribute of the street-parked vehicle included in the signal obtained from the street-parked vehicle parked in the traffic area (S13b). When second determiner 22 determines that no blind spot is present (No in S13b), second determiner 22 makes “visible determination”, and determines whether the interval at which each second communication terminal 11 receives the signals emitted by the first moving body is continuous (S21). When second determiner 22 determines that the interval at which each second communication terminal 11 receives the signals emitted by the first moving body is not continuous (No in S21), the process proceeds to step S25 that is the “invisible determination”. The phrase “the interval is continuous” means that the signals cannot be received at predetermined time intervals and does not mean that the signals are received completely all the time. For example, in FIG. 8A, at time T=a, the first moving bodies for which “visible determination” has been made are P2 and P4, and the first moving bodies for which “invisible determination” has been made are P1 and P3.

When second determiner 22 determines that the interval at which second communication terminals 11 receive the signals emitted by the first moving body is continuous (Yes in S21), second determiner 22 makes “visible determination” (S22), and first determiner 21 determines whether or not the second moving body has overtaken or passed the first moving body (S23).

When first determiner 21 determines that the second moving body has not overtaken or passed the first moving body (No in S23), hazard level determination device 2 returns the process to step S22.

On the other hand, when first determiner 21 determines that the second moving body has overtaken or passed the first moving body (Yes in S23), hazard level determination device 2 ends the processes in the flowchart of FIG. 14. Hazard level determination device 2 may return the process to step S11 and repeat the processes in the flowchart of FIG. 14.

Now, referring back to S13b, when second determiner 22 determines that there is a blind spot for which “invisible determination” is made (Yes in S13b), second determiner 22 determines whether the first moving body is obscured in a blind spot (S24). When second determiner 22 determines that the first moving body is not obscured in a blind spot (No in S24), second determiner 22 returns the process to step S12a.

When second determiner 22 determines that the first moving body is not obscured in a blind spot (Yes in S24), second determiner 22 makes “invisible determination” (S25) and first determiner 21 determines whether or not the second moving body has overtaken or passed the first moving body (S26).

When first determiner 21 determines that the second moving body has not overtaken or passed the first moving body (No in S26), hazard level determination device 2 returns the process to step S25.

On the other hand, when first determiner 21 determines that the second moving body has overtaken or passed the first moving body (Yes in S26), hazard level determination device 2 ends the processes in the flowchart of FIG. 14. Hazard level determination device 2 may return the process to step S11 and repeat the processes in the flowchart of FIG. 14.

Note that the traveling speeds of each first moving body and the second moving body are considered to change over time. However, because the processes in the flowchart of FIG. 14 are repeated, even when the traveling speeds of each first moving body and the second moving body change over time, the hazard level can be determined in real time according to the changes.

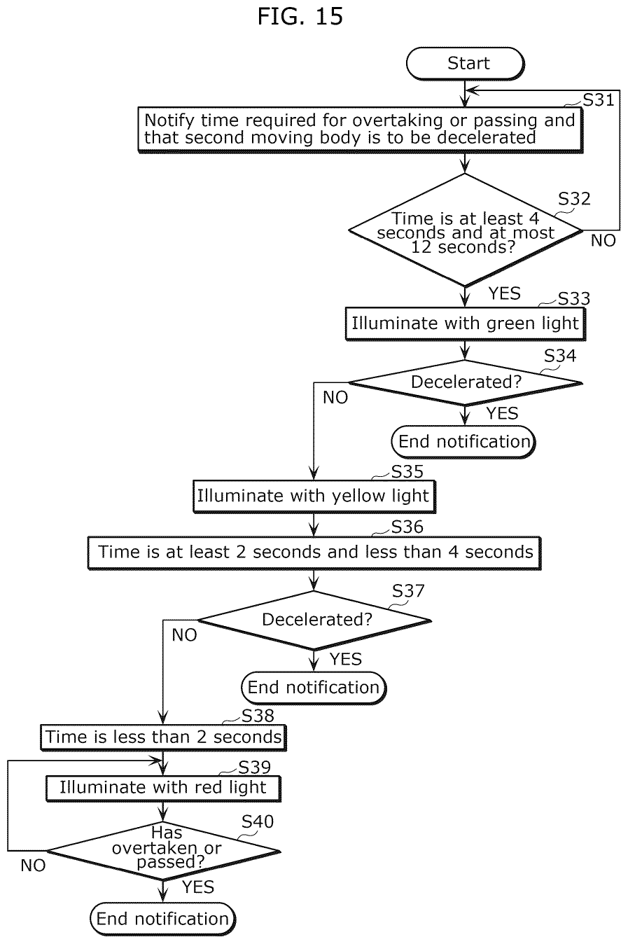

With reference to FIG. 15, another operation example of hazard level determination system 1 that includes hazard level determination device 2, the hazard level determination method, and the program will be described.

FIG. 15 is a flowchart illustrating an operation example in which the color of the light emitted by notifier 30 is changed according to the time required for the second moving body to overtake or pass the first moving body.

The processes that are identical to those in the operation example illustrated in FIG. 15 are marked with the same reference numerals and the descriptions thereof are omitted as appropriate.

In FIG. 15, when notifier 30 notifies the user that the second moving body is to be decelerated, the user decelerates the second moving body. In this case, a greater deceleration would cause discomfort to the user. Therefore, notifier 30 is configured to change the notification mode according to the magnitude of deceleration.

First, notifier 30 notifies the user of the time required for the second moving body to overtake or pass the first moving body and that the second moving body is to be decelerated (S31).

Next, first determiner 21 determines whether the time required for the second moving body to overtake or pass the first moving body is at least 4 seconds and at most 12 seconds (S32). When first determiner 21 determines that the time required for the second moving body to overtake or pass the first moving body is not at least 4 seconds and at most 12 seconds (No in S32), the process returns to step S31.

On the other hand, when first determiner 21 determines that the time required for the second moving body to overtake or pass the first moving body is at least 4 seconds and at most 12 seconds (Yes in S32), display unit 32 of notifier 30 lights up with green light (S33) or indicates the time in green.

Next, third determiner 23 determines whether the second moving body has decelerated, based on information indicating the traveling speed of the second moving body obtained from vehicle speed sensor 10 (S34). When third determiner 23 determines that the second moving body has decelerated (Yes in S34), third determiner 23 ends the processes in the flowchart of FIG. 15.

On the other hand, when third determiner 23 determines that the second moving body has not decelerated (No in S34), display unit 32 of notifier 30 lights up with yellow light (S35) or indicates the time in yellow.

Next, when first determiner 21 determines that the time required for the second moving body to overtake or pass the first moving body is at least 2 seconds and less than 4 seconds (S36), third determiner 23 determines whether the second moving body has decelerated, based on information indicating the traveling speed of the second moving body obtained from vehicle speed sensor 10 (S37). When third determiner 23 determines that the second moving body has decelerated (Yes in S37), the processes in the flowchart of FIG. 15 end.

On the other hand, when third determiner 23 determines that the second moving body has not decelerated (No in S37) and the time required for the second moving body to overtake or pass the first moving body is less than 2 seconds (S38), display unit 32 of notifier 30 lights up with red light (S39) or indicates the time in red.

Next, first determiner 21 determines whether the second moving body has overtaken or passed the first moving body (S40).

When first determiner 21 determines that the second moving body has not overtaken or passed the first moving body (No in S40), hazard level determination device 2 returns the process to step S39.

On the other hand, when first determiner 21 determines that the second moving body has overtaken or passed the first moving body (Yes in S40), hazard level determination device 2 ends the processes in the flowchart of FIG. 15. Hazard level determination device 2 may return the process to step S31, and repeat the processes in the flowchart of FIG. 15.

Display unit 32 may be capable of changing the brightness of the light emitted as well as the color. In addition, display unit 32 may be an interior light provided to the vehicle. In this case, the interior light may be turned on when it needs to be lit with yellow light or when it needs to be lit with red light.

Note that the traveling speeds of each first moving body and the second moving body are considered to change over time. However, because the processes in the flowchart of FIG. 15 are repeated, even when the traveling speeds of the first moving bodies and the second moving body change over time and the time required for the second moving body to overtake or pass the first moving body changes, the color that notifier 30 lights up can be changed in real time in response to the changes.

### Operations and Effects

Next, operations and effects of hazard level determination system 1 that includes hazard level determination device 2, the hazard level determination method and the program according to the present embodiment will be described.

For example, it is difficult to predict the behaviors of surrounding moving bodies in PTL 1, and there is a need for safety support to users to reduce occurrence of accidents.

In view of this, as described above, hazard level determination device 2 according to technique 1 of the present embodiment is hazard level determination device 2 that is provided to a second moving body traveling in a traffic area, the second moving body obtaining a signal output by a first moving body traveling in the traffic area, the first moving body outputting the signal to a surrounding area of the first moving body. Hazard level determination device 2 includes: a communication terminal that obtains the signal; state calculator 26 that estimates a position and a traveling speed of the first moving body based on the signal obtained, and calculates a time required for the second moving body to overtake or pass the first moving body, based on the position and the traveling speed of the first moving body estimated and a position and a traveling speed of the second moving body obtained in advance; and hazard level determiner 24 that determines a hazard level of the first moving body for the second moving body based on a result of calculation performed by state calculator 26 and outputs the hazard level determined.

With this, it is possible to determine the hazard level of the first moving body for the second moving body, allowing the user of the second moving body to recognize the hazard level.

Therefore, according to hazard level determination device 2, safety support can be provided to the user.

Moreover, hazard level determination device 2 according to technique 2 of the present embodiment is hazard level determination device 2 according to technique 1 in which state calculator 26 includes first determiner 21 that determines whether or not the second moving body will overtake or pass the first moving body that is present in front of the second moving body, and first determiner 21 calculates the time required for the second moving body to overtake or pass the first moving body that is present in front of the second moving body, when first determiner 21 determines that the second moving body will overtake or pass the first moving body that is present in front of the second moving body.

With this, the user is able to recognize the time required for the second moving body to overtake or pass the first moving body. This allows the user to take actions such as changing the traveling speed of the second moving body.

Moreover, hazard level determination device according to technique 3 of the present embodiment is hazard level determination device 2 according to technique 1 or technique 2 in which, when a street-parked vehicle is parked in the traffic area, the street-parked vehicle outputs a signal to a surrounding area of the street-parked vehicle, the street-parked vehicle being a vehicle parked on a street and preventing traveling of the first moving body and traveling of the second moving body, state calculator 26 further includes second determiner 22 that identifies a blind spot where the first moving body is obscured by the street-parked vehicle and determines whether the first moving body is obscured in the blind spot identified, and when second determiner 22 determines that the first moving body is obscured in the blind spot, second determiner 22 calculates the time required for the second moving body to overtake or pass the first moving body obscured in the blind spot.

With this, blind spots can be identified. Since signals can be obtained from the first moving body obscured in a blind spot, the user is able to recognize the time required for the second moving body to overtake or pass the first moving body obscured in the blind spot. This allows the user to take actions such as changing the traveling speed of the second moving body.

Moreover, hazard level determination device 2 according to technique 4 of the present embodiment is hazard level determination device 2 according to technique 2 or technique 3 that further includes: notifier 30 that is provided to the second moving body. Notifier 30 outputs the time required for the second moving body to overtake or pass the first moving body and the hazard level for the second moving body determined by hazard level determiner 24.

With this, the user is able to recognize the time required for the second moving body to overtake or pass the first moving body and the hazard level. This allows the user to take actions such as changing the traveling speed of the second moving body.

Moreover, in hazard level determination device 2 according to technique 5 of the present embodiment, state calculator 26 further includes third determiner 23 that determines whether the traveling speed of the second moving body has changed after the time is calculated, based on the traveling speed of the second moving body, and when third determiner 23 determines that the traveling speed of the second moving body has changed, third determiner 23 calculates the time required for the second moving body to overtake or pass the first moving body, based on a result of determination performed by third determiner 23.

With this, even when the traveling speed of the second moving body changes, it is possible to output the time required for the second moving body to overtake or pass the first moving body and the hazard level, taking into account the change in the traveling speed of the second moving body.

Moreover, hazard level determination device 2 according to technique 6 of the present embodiment is hazard level determination device 2 according to technique 5 that further includes: notifier 30 that is provided to the second moving body and outputs information output from hazard level determiner 24. When third determiner 23 determines that the traveling speed of the second moving body has changed, hazard level determiner 24 outputs, to notifier 30, the time required for the second moving body to overtake or pass the first moving body and the hazard level for the second moving body determined by hazard level determiner 24.

With this, the user is able to recognize the time required for the second moving body to overtake or pass the first moving body, which is the time after the change in the traveling speed of the second moving body is taken into consideration. This allows the user to take actions such as changing the traveling speed of the second moving body.

Moreover, hazard level determination device 2 according to technique 7 of the present embodiment is hazard level determination device 2 according to any one of technique 1 to technique 6 in which the signal includes an attribute of the first moving body, the attribute indicating a feature and a property of the first moving body.

With this, since it is possible to determine the hazard level taking into account the attributes of the first moving body, the user is able to recognize the hazard level with a higher accuracy.

Moreover, hazard level determination device 2 according to technique 8 of the present embodiment is hazard level determination device 2 according to any one of technique 1 to technique 7 in which the signal output by the street-parked vehicle includes an attribute of the street-parked vehicle, the attribute indicating a feature and a property of the street-parked vehicle.

With this, it is possible to recognize the presence of a first moving body obscured in a blind spot, taking into account the attributes of the street-parked vehicle, and to determine the hazard level of the second moving body taking into account the presence of the first moving body. Therefore, the user is able to recognize the hazard level with a higher accuracy.

Hazard level determination device 2 according to technique 9 of the present embodiment is hazard level determination device 2 according to any one of technique 1 to technique 8 in which the traffic area includes an installed object, the installed object incudes a terminal that outputs a signal to a surrounding area of the installed object, and the signal output by the terminal includes an attribute of the installed object, the attribute indicating a feature and a property of the installed object.

With this, it is possible to recognize the presence of the first moving body obscured in a blind spot, taking into account the attributes of the installed object, and to determine the hazard level of the second moving body, taking into account the presence of the first moving body. Therefore, the user is able to recognize the hazard level with a higher accuracy.

A hazard level determination method according to technique 10 of the present embodiment is a hazard level determination method performed by a second moving body traveling in a traffic area, the second moving body obtaining a signal output by a first moving body traveling in the traffic area, the first moving body outputting the signal to a surrounding area of the first moving body. The hazard level determination method includes: obtaining, by a communication terminal, the signal, estimating, by state calculator 26, a position and a traveling speed of the first moving body based on the signal obtained, and calculating, by state calculator 26, a time required for the second moving body to overtake or pass the first moving body, based on the position and the traveling speed of the first moving body estimated and a position and a traveling speed of the second moving body obtained in advance; and determining, by hazard level determiner 24, a hazard level of the first moving body for the second moving body based on a result of the calculating performed by state calculator 26, and outputting, by hazard level determiner 24, the hazard level determined.

This method also provides the same operations and effects as described above.

A program according to technique 11 of the present embodiment is a program for causing a computer to execute the hazard level determination method according to technique 10.

The program also provides the same operations and effects as described above.

### Other Variations

Although the hazard level determination device according to the present disclosure has been described based on the embodiment described above, the present disclosure is not limited to the embodiment. The forms obtained by various modifications to the embodiment that can be conceived by a person of skill in the art within the scope of the essence of the present disclosure may also be included in the present disclosure.

For example, the state calculator in the hazard level determination device according to the embodiment described above is implemented as a large scale integration (LSI) which is typically an integrated circuit. They may be individually configured as single chips or may be configured so that part or all are included in a single chip.

The method of circuit integration is not limited to LSIs, and implementation through a dedicated circuit or a general-purpose processor is also possible. A field programmable gate array (FPGA) that can be programmed after the LSI is manufactured or a reconfigurable processor in which the connection and settings of circuit cells inside the LSI can be reconfigured may be used.

In the embodiment described above, each structural element may be configured in the form of a dedicated hardware product or realized by executing a software program suitable for each structural element. Each of the structural elements may be realized by means of a program executing unit, such as a central processing unit (CPU) and a processor, reading and executing the software program recorded on a recording medium, such as a hard disk or a semiconductor memory.

Moreover, all numerical figures used in the forgoing description are merely examples for describing the present disclosure in specific terms, and thus the embodiment according to the present disclosure is not limited to the illustrated numerical figures.

Furthermore, the separation of the function blocks in the block diagrams is merely an example, and plural function blocks may be implemented as a single function block, a single function block may be separated into plural function blocks, or part of functions of a function block may be transferred to another function block. Furthermore, the functions of function blocks having similar functions may be processed in parallel or in a time division manner by a single hardware or software.

Moreover, the sequence in which the above-described steps included in the flowcharts are executed is given as an example to describe the present disclosure in specific terms, and thus other sequences are possible. Part of the above-described steps may be executed simultaneously (in parallel) with another step.

Various modifications to the present embodiment that can be conceived by those skilled in the art, and forms configured by combining the structural elements and functions in the embodiment without departing from the teachings of the present disclosure are also included in the present disclosure.

While an embodiment has been described herein above, it is to be appreciated that various changes in form and detail may be made without departing from the spirit and scope of the present disclosure as presently or hereafter claimed.

### Further Information About Technical Background to This Application

The disclosures of the following patent applications including specification, drawings, and claims are incorporated herein by reference in their entirety: Japanese Patent Application No. 2024-226219 filed on Dec. 23, 2024, and Japanese Patent Application No. 2025-157202 filed on Sep. 22, 2025.

### INDUSTRIAL APPLICABILITY

The present disclosure is applicable to, for example, vehicles such as two-wheelers, motorcycles, and automobiles, and portable terminals carried by people.

1. A hazard level determination device that is provided to a second moving body traveling in a traffic area, the second moving body obtaining a signal output by a first moving body traveling in the traffic area, the first moving body outputting the signal to a surrounding area of the first moving body, the hazard level determination device comprising:
a communication terminal that obtains the signal;
a state calculator that estimates a position and a traveling speed of the first moving body based on the signal obtained, and calculates a time required for the second moving body to overtake or pass the first moving body, based on the position and the traveling speed of the first moving body estimated and a position and a traveling speed of the second moving body obtained in advance; and
a hazard level determiner that determines a hazard level of the first moving body for the second moving body based on a result of calculation performed by the state calculator and outputs the hazard level determined.

2. The hazard level determination device according to claim 1,
wherein the state calculator includes a first determiner that determines whether or not the second moving body will overtake or pass the first moving body that is present in front of the second moving body, and
the first determiner calculates the time required for the second moving body to overtake or pass the first moving body that is present in front of the second moving body, when the first determiner determines that the second moving body will overtake or pass the first moving body that is present in front of the second moving body.

3. The hazard level determination device according to claim 1,
wherein, when a street-parked vehicle is parked in the traffic area, the street-parked vehicle outputs a signal to a surrounding area of the street-parked vehicle, the street-parked vehicle being a vehicle parked on a street and preventing traveling of the first moving body and traveling of the second moving body,
the state calculator further includes a second determiner that identifies a blind spot where the first moving body is obscured by the street-parked vehicle and determines whether the first moving body is obscured in the blind spot identified, and
when the second determiner determines that the first moving body is obscured in the blind spot, the second determiner calculates the time required for the second moving body to overtake or pass the first moving body obscured in the blind spot.

4. The hazard level determination device according to claim 2, further comprising:
a notifier that is provided to the second moving body,
wherein the notifier outputs the time required for the second moving body to overtake or pass the first moving body and the hazard level for the second moving body determined by the hazard level determiner.

5. The hazard level determination device according to claim 1,
wherein the state calculator further includes a third determiner that determines whether the traveling speed of the second moving body has changed after the time is calculated, based on the traveling speed of the second moving body, and
when the third determiner determines that the traveling speed of the second moving body has changed,
the third determiner calculates the time required for the second moving body to overtake or pass the first moving body, based on a result of determination performed by the third determiner.

6. The hazard level determination device according to claim 5, further comprising:
a notifier that is provided to the second moving body and outputs information output from the hazard level determiner,
wherein, when the third determiner determines that the traveling speed of the second moving body has changed, the hazard level determiner outputs, to the notifier, the time required for the second moving body to overtake or pass the first moving body and the hazard level for the second moving body determined by the hazard level determiner.

7. The hazard level determination device according to claim 1,
wherein the signal includes an attribute of the first moving body, the attribute indicating a feature and a property of the first moving body.

8. The hazard level determination device according to claim 3,
wherein the signal output by the street-parked vehicle includes an attribute of the street-parked vehicle, the attribute indicating a feature and a property of the street-parked vehicle.

9. The hazard level determination device according to claim 1,
wherein the traffic area includes an installed object,
the installed object incudes a terminal that outputs a signal to a surrounding area of the installed object, and
the signal output by the terminal includes an attribute of the installed object, the attribute indicating a feature and a property of the installed object.

10. A hazard level determination method performed by a second moving body traveling in a traffic area, the second moving body obtaining a signal output by a first moving body traveling in the traffic area, the first moving body outputting the signal to a surrounding area of the first moving body, the hazard level determination method comprising:
obtaining, by a communication terminal, the signal,
estimating, by a state calculator, a position and a traveling speed of the first moving body based on the signal obtained, and calculating, by the state calculator, a time required for the second moving body to overtake or pass the first moving body, based on the position and the traveling speed of the first moving body estimated and a position and a traveling speed of the second moving body obtained in advance; and
determining, by a hazard level determiner, a hazard level of the first moving body for the second moving body based on a result of the calculating performed by the state calculator, and outputting, by the hazard level determiner, the hazard level determined.

11. A non-transitory computer-readable storage medium for use in a computer, the storage medium having recorded thereon a computer program for causing the computer to execute the hazard level determination method according to claim 10.
